(19) United States
(12) Patent Application Publication
(10) Pub. No.: US 2018/0289192 A1
(43) Pub. Date: Oct. 11, 2018

(54) PLAY MAT WITH DECORATIVE ELEMENTS MATCHING DÉCOR

(71) Applicant: Linda Tong, Westminster, CA (US)

(72) Inventor: Linda Tong, Westminster, CA (US)

(21) Appl. No.: 15/480,629

(22) Filed: Apr. 6, 2017

(51) Int. Cl. A47G 27/02; A47D 15/00; B32B 5/18; B32B 7/06; B32B 27/08

(52) U.S. Cl. CPC A47G 27/0212; A47D 15/001; A47G 27/0275; A47G 27/0281; B32B 5/18; B32B 2471/04; B32B 27/08; B32B 2307/726; B32B 2307/7265; B32B 2307/744; B32B 2451/00; B32B 7/06

(57) ABSTRACT

A multi-layer play surface comprises a plurality of layers, wherein at least one layer is a decorative outer layer selected based on one or more environmental factors, and at least one bottom layer comprising a slip-resistant outer surface.

### CROSS-REFERENCE TO RELATED APPLICATION(S)

Not applicable

### BACKGROUND OF THE INVENTION

### 1. Field of Invention

The present invention relates to the field of hygienic mats. More particularly to multi-layered for use with children and mats having a textured or patterned surface.

### 2. Description of Related Art

Child development involves, among other things, tactile stimuli and interaction to form positive interpersonal relationship. When a child is young, it is common for family members to interact on the ground to avoid the risk of injury resulting from a fall off of an elevated surface. While the ground may reduce fall related injuries, it also presents a number of other concerns including contact with microorganisms that have been transferred from the bottom of people's shoes or feet as they previously walked across the area where the family would interact with the child.

Current attempts have been made to provide for soft mats defining dedicated areas for the family to interact with the child. As these mats have the specific purpose for use with children, they are often presented with a single aesthetic appearance that is meant to be enjoyed by the child. Examples of such appearance would include bright colors or patterns and others may incorporate fictional characters or scenery. Such limited options require that a family repeatedly store the mat, when it is not in use, or dedicate an entire room in their house to the child, which would allow for an acceptable place to leave the mat out continuously. This is unacceptable as the majority of families are unable to permanently dedicate livable square footage to such a specific use.

Other options exist, where the family provides for a rug or carpet remnant to be used in lieu of a mat, as the rug or carpet remnant would be better suited to match their decor. However, rugs and mats only compound the issue of creating a surface filled with dirt, debris, and microorganisms.

In both of the described current options for meeting this need, the family is obligated to repeatedly purchase new mats, rugs, and remnants as the child grows and/or as the decor of the home changes. Such practice results in unnecessary costs and unnecessary production of waste.

Based on the foregoing, there is a need in the art for a children's play mat or surface that will provide the security and hygienic characteristics required for use with a child, while allowing for adaptability to changing styles of the family, the child, and their home.

### SUMMARY OF THE INVENTION

A multi-layer play surface comprises a plurality of layers, wherein at least one layer is a decorative outer layer selected based on one or more environmental factors, and at least one bottom layer.

In an embodiment, the multi-layer play surface further comprises at least one resilient layer separating the outer layer and the at least one bottom layer, wherein a perimeter of the play surface is tapered, wherein the outer layer is attached at a seam to the at least one bottom layer, and wherein the seam compresses the at least one resilient layer.

In an embodiment, film is attached to a middle foam layer through a heat treatment process.

In an embodiment, the multi-layer play surface further comprises a plurality of columns separating the outer layer and the at least one bottom layer, wherein the plurality of columns comprise a resilient material, and wherein the plurality of columns facilitate the flow of liquids through the play surface.

In an embodiment, the outer layer and one or more intervening layers separating the outer layer and the at least one bottom layer are permeable.

In an embodiment, the bottom layer is non-permeable, and wherein an interior surface of the bottom layer facilitates removal of fluids passed through the outer layer and the one or more intervening layers.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of a play mat with decorative matching outer surface, according to an embodiment of the present invention;

FIG. 2 is a perspective view of a play mat with decorative matching outer surface, according to an embodiment of the present invention;

### DETAILED DESCRIPTION OF PREFERRED EMBODIMENTS

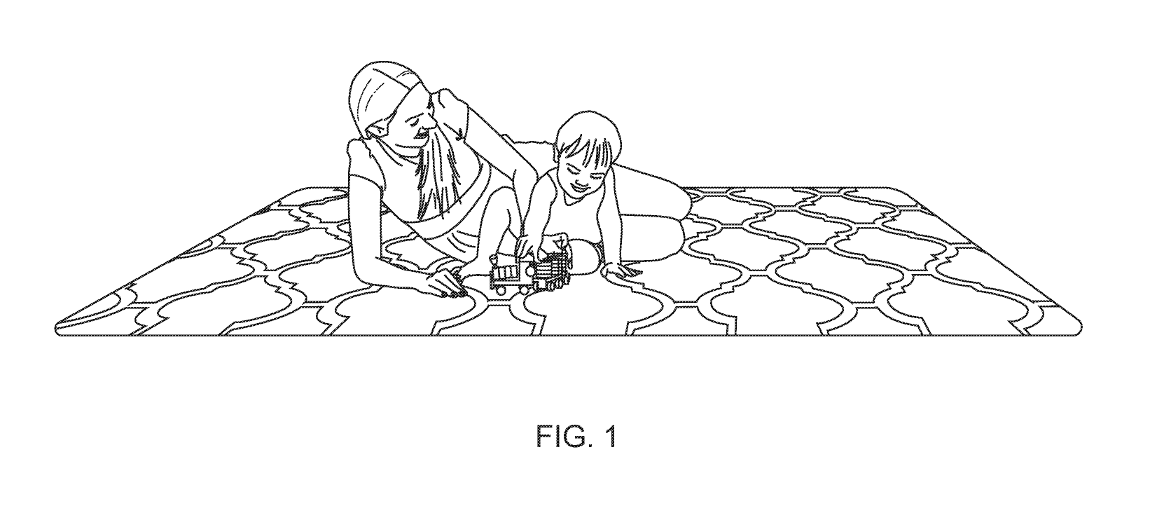

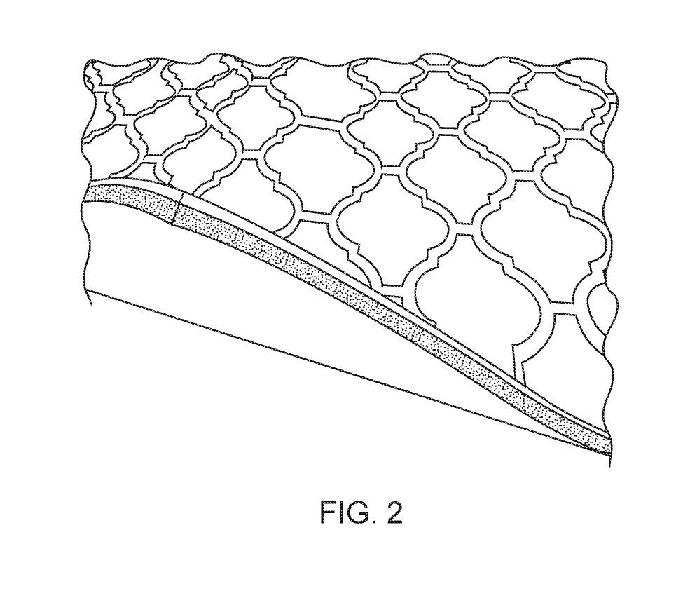

Preferred embodiments of the present invention and their advantages may be understood by referring to FIGS. 1-2, wherein like reference numerals refer to like elements.

An adaptable children's mat has at least one layer of material with a tapered perimeter. The at least one layer has a bottom and a top surface where the top surface is visible to the user and provides for useable surface area.

The children's mat may have multiple layers. A first layer is provided to contact a floor. The first layer may be textured or comprise a material to promote a positive contact with the floor preventing the mat from sliding out of position. The remaining layers are disposed on top of the first layer. Each of the multiple layers have a combination of one or all of the following characteristics: BPA-free, non-toxic, latex-free, waterproof, hypoallergenic, mite resistant, lead-free, PVC-free, Mercury-free, Anti-slip texture, and flame resistant. Each layer may comprise one or more of the aforementioned characteristics promoting safe contact with users.

A final layer is separated from the first layer by intervening layers. The final layer covers the remaining layers such that the final layer obscures the remaining layers. The final layer provides one or more visual elements, wherein the visual elements are predetermined based on user preference. In an embodiment, user preference is determined based on the style of the decor of the room the mat is to be placed. For example, if the user has established a color pallet of cool-type colors throughout the room, the final layer of the mat is provided to fit within the pre-established style scheme. Where the user has established a style based on texture or patterns, the final layer is provided to reflect such style.

In an embodiment, the final layer is removably attached to the other layers. The removeable attachment is facilitated by the perimeter of the final layer, whereby the perimeter is configured to envelope a perimeter of the remaining layers. The final layer perimeter may be provided with a resilient element disposed within the final layer perimeter such that the final layer is pulled over the perimeter of the other layers and is retained in place over the other layers as the resilient element retracts maintaining a positive attachment between the final layer perimeter and the perimeter of the other layers. In another embodiment, the final layer has one or more attachments on its bottom surface disposed such that the one or more attachments contact an upper surface of the other layers. The one or more attachments may include a hook and loop attachment, a reusable adhesive contacting surface between the bottom surface and the upper surface of the other layers, or one or more clips configured to hold the final layer in place on the other layers.

In an embodiment, the intervening layers between the first layer and the final layer are porous or permeable allowing for the flow of fluids split thereon to pass through. In another embodiment, the first layer is also porous allowing for the fluid to pass through to the floor. In an alternative embodiment, the first layer is continuous such that it retains the fluid passed through the remaining layers for easy disposal. In use, when fluid is spilled on the mat, it passes through the permeable material or porous material until it reaches the first layer. The first layer may be separated from the next layer through one or more columns creating a void between the first layer and the next layer to allowing the user to pick up the entire mat and dump the water retained on the first layer.

In an alternative embodiment, all of the layers are water resistant or water repellant allowing for fluids spilled thereon to be transferred from the mat surface by adjusting the angle of the mat relative to the floor, such that the fluids flow off of the mat.

The thickness of the mat directly correlates with the aggregate thickness of each of the layers. The layers may be encapsulated within the decorative outer surface and a slip-resistant bottom later whereby the tapered edges are formed due to the compression neat the attachment of a peripheral edge of the mat where the decorative outer surface is attached at a seam to the slip-resistant bottom surface.

The interior of the mat is sufficiently flexible and resilient to prevent injury of a user falling thereon. For example, the inner layers separating the decorative outer surface and the bottom surface may be configured as described above in conjunction with foam or other soft compression material.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A multi-layer play surface comprising:
a. a plurality of layers, wherein at least one layer is a decorative outer layer selected based on one or more environmental factors, wherein the one or more environmental factors is an existing decor;
b. and at least one bottom layer.

2. The multi-layer play surface of claim 1, further comprising at least one resilient layer separating the outer layer and the at least one bottom layer, wherein a perimeter of the play surface is tapered, wherein the outer layer is attached at a seam to the at least one bottom layer, and wherein the seam compresses the at least one resilient layer.

3. The multilayer play surface of claim 1, further comprising a plurality of columns separating the outer layer and the at least one bottom layer, wherein the plurality of columns comprise a resilient material, and wherein the plurality of columns facilitate the flow of liquids through the play surface.

4. The multi-layer play surface of claim 1, wherein the outer layer and one or more intervening layers separating the outer layer and the at least one bottom layer are permeable.

5. The multi-layer play surface of claim 4, wherein the bottom layer is non-permeable, and wherein an interior surface of the bottom layer facilitates removal of fluids passed through the outer layer and the one or more intervening layers.

6. The multi-layer play surface of claim 1, wherein the at least one bottom layer comprises a slip-resistant outer surface.

7. The multi-layer play surface of claim 6, wherein the decorative outer layer comprises a slip-resistant outer surface
